(19) United States
(12) Patent Application Publication
(10) Pub. No.: US 2020/0360748 A1
(43) Pub. Date: Nov. 19, 2020

(54) Fire Sprinkler Station Mobile

(71) Applicant: Marcus Henry Welles, Hampton, GA (US)

(72) Inventor: Marcus Henry Welles, Hampton, GA (US)

(21) Appl. No.: 16/416,155

(22) Filed: May 18, 2019

(51) Int. Cl. A62C 27/00; A62C 37/38; A62C 37/36

(52) U.S. Cl. CPC A62C 27/00; A62C 37/04; A62C 37/38

(57) ABSTRACT

A system for fighting fire, includes a timer unit with an electrical power input and out line. The timer is connected to a flow switch that response to water movement. The water movement occurs when the glass bulb shatters in a sprinkler head. The glass bulb contains a fluid which expands when exposed to heat. When the rated temperature is reached, the fluid expands sufficiently to shatter the glass bulb, allowing the sprinkler to activate and water to flow. The flow of the water tells the flow switch to turn on the timer that is set for in this example one hundred and ten seconds. The timer turns on the pump. The pump gets it water from a water tank. The pump forces the water threw the pressurize pipe system to one or more sprinkler heads. The pressure is maintain by check valves, that hold a constant 40 psi. This system is mobile. The system will need to be maintain every six month. After the system puts out a fire it will need be reset.

### REFERENCE TO RELATED APPLICATION

The present application claims priority to provisional patent application No. 62/672,091, filed on May 16, 2018, disclosure of which are incorporated herein at least by reference.

### BACKGROUND OF THE INVENTION

### 1. Field of the Invention

The present invention is in the field of fire fighting in homes and businesses without fire sprinkler systems.

### 2. Description of Related Art

There are countless homes and building without fire sprinklers. Therefore what is needed is a easy to install fire fighting system. Even if you don't own the place you can still add this fire protection system to your current place. Because, it can be taken apart at the check valves, and rolled onto the moving truck.

Therefore, what is clearly needed is a mobile fire fighting system method that solves the problem mentioned above.

### BRIEF SUMMARY OF THE INVENTION

In one embodiment of the invention a system for fighting fire is provided, comprising a timer unit with an electrical power input and out line. A flow switch that response to water movement. The water movement occurs when the glass bulb shatters in a sprinkler head. A sprinkler head that contains a glass bulb containing a fluid which expands when exposed to heat. A flow switch that water passes threw, and tells the timer to turn on the pump. A water tank that gravity feeds the pump, the pump forces the water threw the pressurize pipe system to one or more sprinkler heads. The pressure is maintain by check valves, that hold a constant 40 psi.

Also in one embodiment the water is released when a glass bulb shatter from to much heat, in a quick response sprinkler head. Also in one embodiment, the water passes threw the flow switch, activating the timer, the timer is set to run for a designated time. The timer turns on the pump that forces water from the water tank out the discharge port into the pipe system. The water pass threw the pipe system to one of three sprinkler heads extinguishing the fire. The timer runs out of time and turns off the pump. The system needs to be reset.

### BRIEF DESCRIPTION OF THE SEVERAL VIEWS OF THE DRAWINGS

FIG. 1 is an elevated view of the quick response sprinkler system according to an embodiment of the present invention.

FIG. 2 is an perspective view of a fire fighting system according to an embodiment of the present invention.

FIG. 3 is an front view of a fire fighting system according to an embodiment of the present invention.

FIG. 4 is an side view of the fire fighting system according to an embodiment of the present invention.

FIG. 5 is an back view of the fire fighting system according to an embodiment of the present invention.

FIG. 6 is an perspective view of the fire fighting system, with a cabinet according to a further embodiment of the present invention

FIG. 7 is an elevated view of the timer of the fire fighting system according to an embodiment of the present invention.

FIG. 8 is and perspective exploded view of the fire fighting system according to an embodiment of the present invention.

FIG. 9 is an process flow chart illustrating steps for fire fighting system in an embodiment of the present invention.

### DETAILED DESCRIPTION OF THE INVENTION

The inventor provides a unique fire sprinkler system on wheels. Enabling fire protection for homes and buildings, without fire protection. The new system can be rolled in and installed easily and for less cost. This example has three sprinkler heads for the kitchen, bedroom, living room. The present invention is described in enabling detail in the following examples, which may represent more than one embodiment of the present invention.

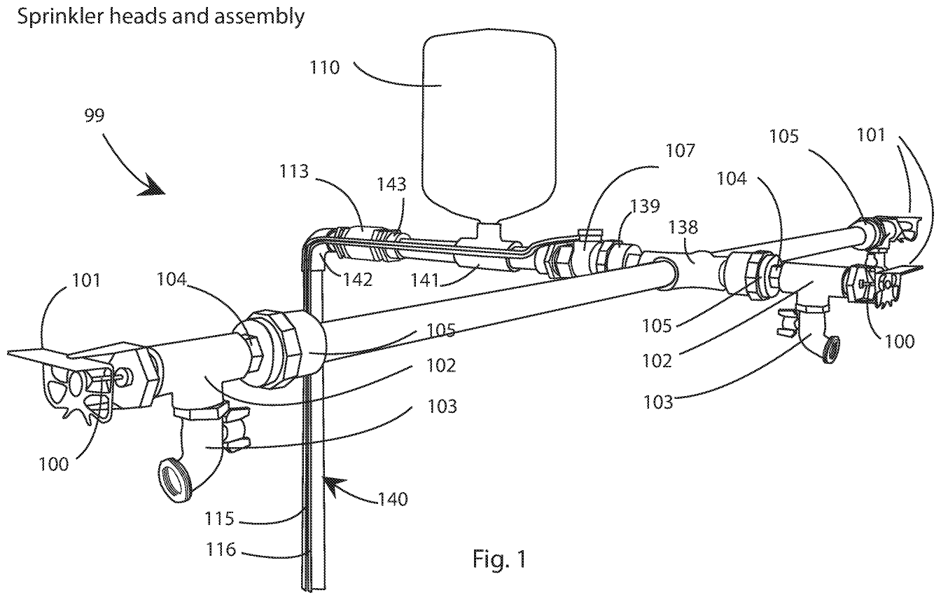

FIG. 1 is a close up perspective view of an fire sprinkler system 99 according to an embodiment of the present invention. Fire sprinkler system 99 is in this example has three sprinkler heads 101. Fire sprinkler system 99 in this view has a flow switch 107. Fire sprinkler system 99 in this view has a expansion tank 110 that has 40 psi of pressure. Fire sprinkler 99 in this view has a three hose valve 103 that is used to pressurize the fire sprinkler system. Fire sprinkler system 99 in this view has a check valve 113 that holds the water and pressure in place. Fire sprinkler system 99 in this view has a glass bulb 100 inside the fire sprinkler.

The glass bulb contains a fluid which expands when exposed to heat. When the rated temperature is reached, the fluid expands sufficiently to shatter the glass bulb, allowing the sprinkler to active, and water to flow. Fire sprinkler system 99 in this example has a expansion tank 110. When the glass bulb 100 brakes the water from the expansion tank 110 flows threw the flow switch 107. When the water pass threw the flow switch 107. Fire sprinkler system 99 is in this example has a timer 133.

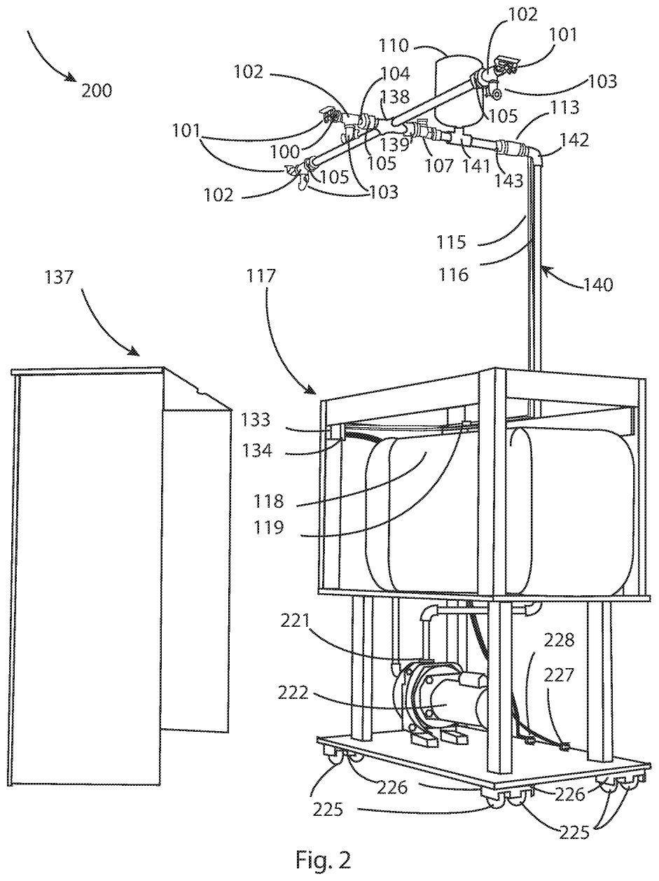

FIG. 2 is a perspective view of fire sprinkler system support structure 200 illustrating a frame 117 structure according to an embodiment of the present invention. In this example the timer 133 is set for one hundred and ten seconds. The timer 133 has been turned on by the flow switch 107. Fire sprinkler system 200 in this view has a pump 222. The pump 222 in this example has two power sources, a pump cord 227 to power the pump 222 to pressurize the fire sprinkler system. In this example the pump 222 has a second power source coming from the timer 133. This is the power that runs the pump for a set time period. When the timer 133 turns the pump 222 on. In this example a discharge port 221 pumps the water. In this example threw a PVC plastic pipe system 140. The water flow to the sprinkler head 101 that the glass bulb has shatter 100 from the heat in the room. In this example the pump 222 empties a water tank 118 after the one hundred and ten seconds. In this example the timer turns off. In this example the fire fighting system needs to be reset.

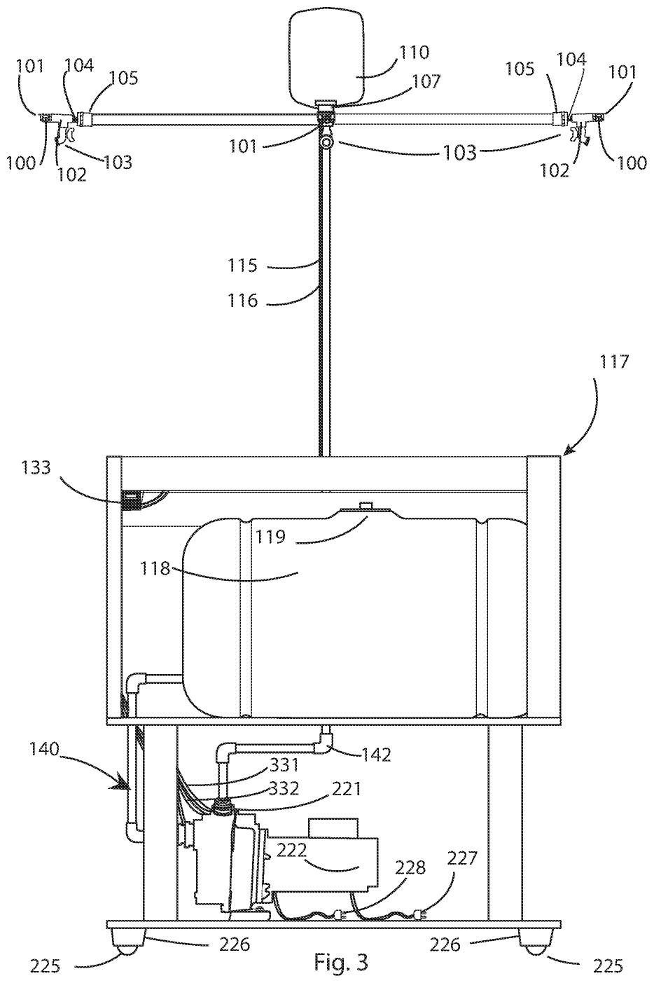

FIG. 3 in this example shows the front view and a tank 118. In this example the water gravity feeds threw 140 to the pump 222.

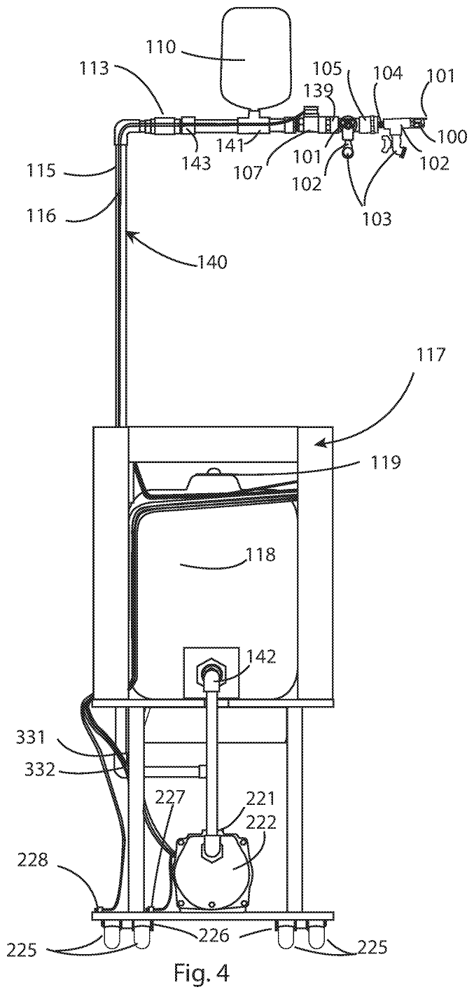

FIG. 4 is a side view of the fire sprinkler system, without cabinet according to an embodiment of the present invention.

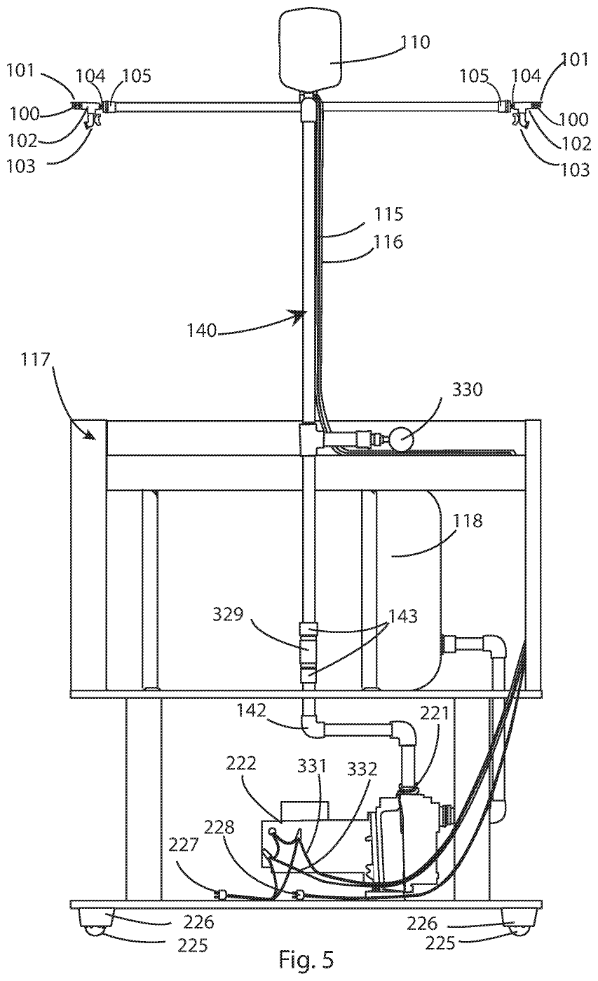

FIG. 5 is a back view of the fire sprinkler system, without cabinet according to an embodiment of the present invention.

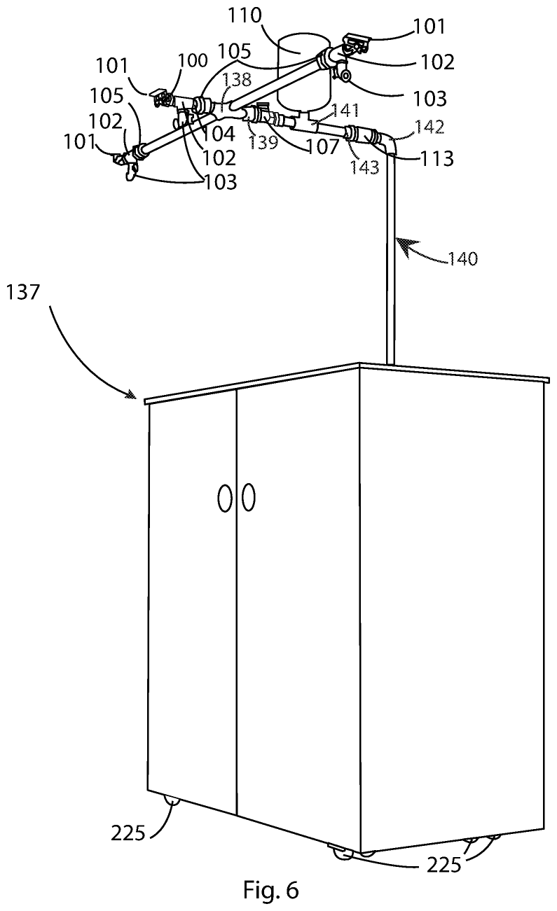

FIG. 6 is a perspective view of the fire sprinkler system with a cabinet 137 according to an embodiment of the present invention.

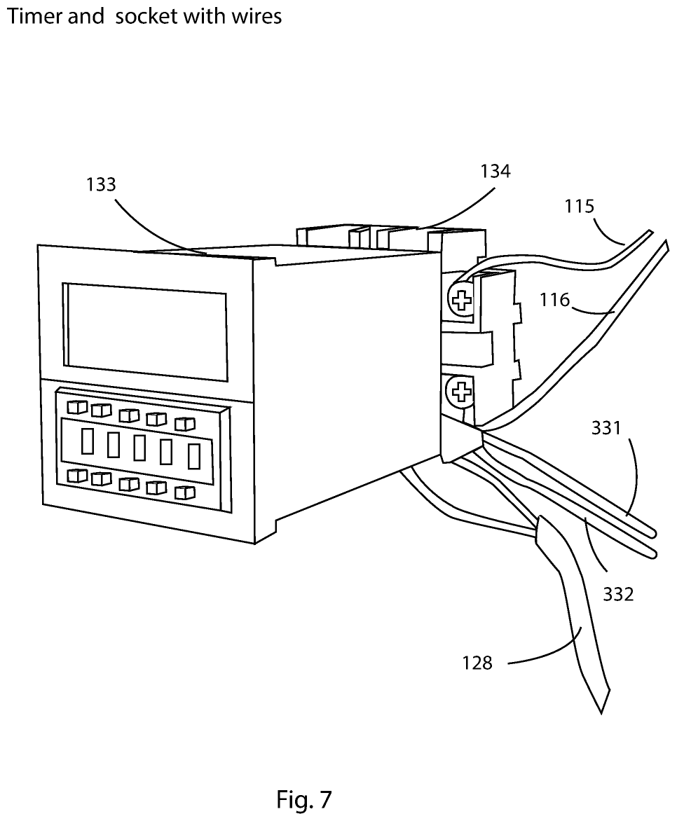

FIG. 7 is a perspective view of the timer unit of FIG. 1 according to an embodiment of the present invention. This embodiment includes a socket 134. This embodiment includes wire 115 from the flow switch 107. This embodiment includes wire 116 from the flow switch 107. These two wires come from the flow switch 107 and turn on the timer 133. Socket unit 134 includes a wire 331 that leads to pump 222. Socket unit 134 includes a wire 332 that leads to pump 222. Wire 331 and 332 power the pump 222 for a set time period. Power into the timer is supplied by AC via a plug 128.

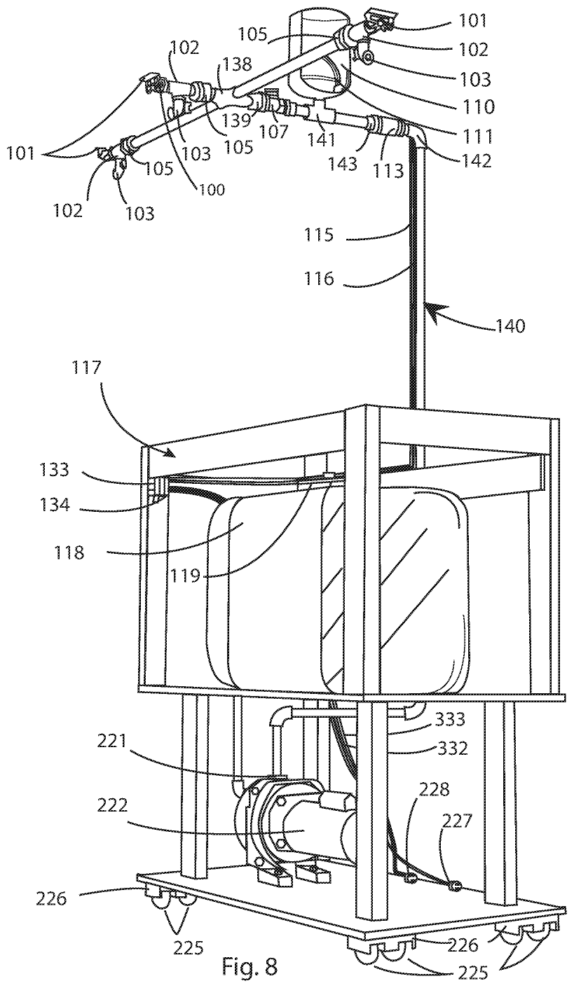

FIG. 8 is a perspective, exploded view drawing of a expansion tank and water tank, according to an embodiment of the present invention. In this embodiment a diaphragm 111 fills with one gallon of water pressurized to 40 psi. When the glass bulb 100 shatters. The water from the diaphragm passes threw the flow switch 107. The flow switch starts the timer.

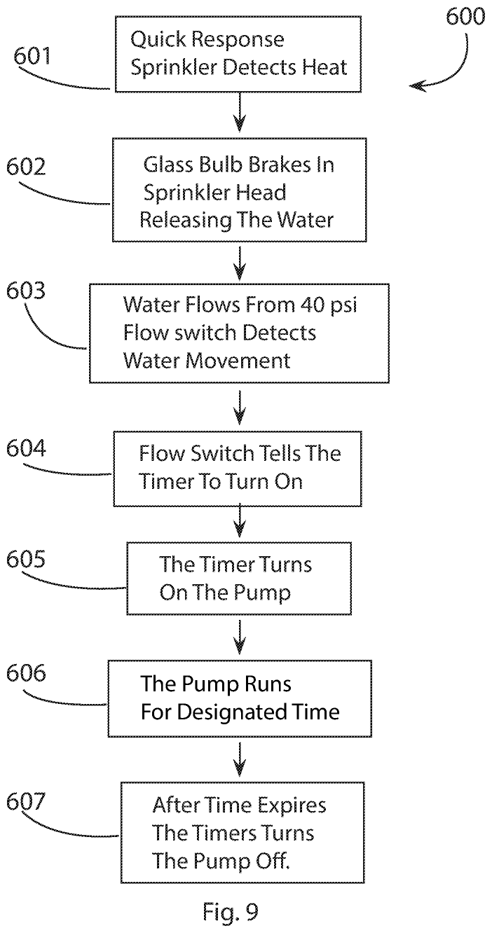

FIG. 9 is a process flow chart a 600 illustrating steps for the fire sprinkler systems according to an embodiment of the present invention. At step 602 glass bulb brakes in sprinkler head from over heating and releases the water.

Step 603 flow switch detects water movement. Step 604 flow switch tells the timer to turn on. Step 605 the timer turns on the pump. Step 606 the pump runs for designated time. Step 607 after time expires the timer turns the pump off.

It will be apparent to one with skill in the art that the fire sprinkler system of the invention may be provided using some or all of the mentioned features and components without departing from the spirit and scope of the present invention. It will also be apparent to the skilled artisan that the embodiments described above are specific examples of a single broader invention which may have greater scope than any of the singular description taught. There may be many alteration made in the description with out departing from the spirit and scope of the present invention.

1) A system for fighting fire, comprising, a timer unit with an electrical power input and out line, and comprising a water tank, and a pump.

2) The timer is connected to a flow switch that responds to water movement.

3) The water movement occurs when a glass bulb shatters in a sprinkler head.

4) The glass bulb contains a fluid which expands when exposed to heat.

5) When the rated temperature is reached, the fluid expands sufficiently to shatter the glass bulb, allowing a sprinkler to activate and water to flow.

6) The flow of the water tells a flow switch to turn on the timer, the timer turns on a pump.

7) The pump gets it water from a water tank, that gravity feeds the water to a pump.

8) The pump forces the water through the pressurized pipe system to one or more sprinkler heads extinguishing the fire.

9) The pressure is maintained by check valves, that hold a constant 40 psi.

10) The 40 psi is used to operate the system, with an expansion tank, that forces water through the flow switch.

11) The system of claim 3, wherein the water is released when a glass bulb is shattered from too much heat, in a quick response sprinkler head.

12) The system of claim 6, wherein the water passes through the flow switch, activating the timer, wherein the timer is set to run for a designated time.

13) The system of claim 6, wherein the timer turns on the pump that runs for one hundred and ten seconds forcing water out the discharge port into the pipe system.

14) The system of claim 1, wherein the timer runs out of time and turns off the pump.

15) The system will need to be reset, with new sprinkler heads, according to how many operated in response to the fire.

16) The system can be taken apart at the check valves and rolled onto a moving truck, it has four swivel wheels for mobility, and can be easily installed and removed.

17) The system will be surface mounted, to run throughout the home, and add fire protection to the activated sprinkler head.

18) The system will be maintained on a 6 month inspection period.
